(19) United States
(12) Patent Application Publication
(10) Pub. No.: US 2019/0383211 A1
(43) Pub. Date: Dec. 19, 2019

(54) VARIABLE GEOMETRY TURBOCHARGERS AND VANE MANIPULATION MECHANISMS THEREFORE

(71) Applicant: GM GLOBAL TECHNOLOGY OPERATIONS LLC, Detroit, MI (US)

(72) Inventor: Alberto Racca, Cavallermaggiore (IT)

(21) Appl. No.: 16/007,345

(22) Filed: Jun. 13, 2018

(51) Int. Cl. F02B 37/24; F16H 19/00; F01D 17/16

(52) U.S. Cl. CPC F02B 37/24; F05D 2220/40; F01D 17/165; F16H 19/001

(57) ABSTRACT

A variable geometry turbocharger (VGT) includes a turbine housing, a turbine wheel disposed within the turbine housing and configured to be rotated by post-combustion gasses communicated to the turbine wheel via a turbine housing inlet, a compressor wheel operably connected to the turbine wheel via a shaft, and a variable position vane mechanism comprising a plurality of movable vanes arranged radially outward from and concentric with the turbine wheel and disposed between the turbine housing inlet and the turbine wheel, wherein each vane comprises an actuating feature configured to be manipulated by a crown disposed radially inward from the plurality of actuating features. The crown includes a central aperture through which the shaft is disposed. Manipulating each of the vanes via the crown can increase or decrease the pressure ratio of VGT. Each actuating feature can be a vane wheel parallel with the crown.

### BACKGROUND

Internal combustion engines (ICE) are often called upon to generate considerable levels of power for prolonged periods of time on a dependable basis. Many such ICE assemblies employ a boosting device, such as an exhaust gas turbine driven turbocharger, to compress the airflow before it enters the intake manifold of the engine in order to increase power and efficiency.

Specifically, a turbocharger is a centrifugal gas compressor that forces more air and, thus, more oxygen into the combustion chambers of the ICE than is otherwise achievable with ambient atmospheric pressure. The additional mass of oxygen-containing air that is forced into the ICE improves the engine's volumetric efficiency, allowing it to burn more fuel in a given cycle, and thereby produce more power.

### SUMMARY

Provided are variable position vane mechanisms for a variable geometry turbocharger. The mechanisms include a plurality of annularly arranged vanes each comprising a vane body and an actuating feature coupled to the vane body via a vane post, a circular crown engaged with the plurality of vane actuating features and disposed concentric therewith and radially inward therefrom. Rotation of the circular crown effects movement of the plurality of vanes. The plurality of actuating features can be vane wheels. Each of the vane wheels can be parallel with the crown. Each of the vane actuating features can include a toothed edge, and the crown can include a toothed peripheral edge configured to engage the toothed edge of each vane actuating feature. The crown can include a central aperture. The variable position vane mechanism can further include a crown actuator coupled to the crown via a linkage assembly and configured to effect rotation of the crown and subsequent movement of the plurality of vanes.

Variable geometry turbochargers (VGT) are provided and include a turbine housing, a turbine wheel disposed within the turbine housing and configured to be rotated by post-combustion gasses communicated to the turbine wheel via a turbine housing inlet, a compressor wheel operably connected to the turbine wheel via a shaft, and a variable position vane mechanism. The variable position vane mechanism includes a plurality of movable vanes arranged radially outward from and concentric with the turbine wheel and disposed between the turbine housing inlet and the turbine wheel. Each vane can include an actuating feature configured to be manipulated by a crown disposed radially inward from the plurality of actuating features. Manipulating each of the vanes via the crown can increase or decrease a pressure ratio of the VGT. The plurality of actuating features can be vane wheels. Each of the vane wheels can be parallel with the crown. Each of the vane actuating features can include a toothed edge, and the crown can include a toothed peripheral edge configured to engage the toothed edge of each vane actuating feature. The crown can include a central aperture through which the shaft is disposed. The VGT can further include a crown actuator configured to effect rotation of the crown and subsequent movement of the plurality of vanes.

A vehicle is also provided, and includes an internal combustion engine. The internal combustion engine includes a cylinder configured to receive an air-fuel mixture for combustion therein, a reciprocating piston disposed inside the cylinder and configured to exhaust post-combustion gasses from the cylinder, and a variable geometry turbocharger (VGT). The VGT includes a turbine housing, a turbine wheel disposed within the turbine housing and configured to be rotated by post-combustion gasses communicated to the turbine wheel via a turbine housing inlet, a compressor wheel operably connected to the turbine wheel via a shaft and configured to pressurize a compressor supply airflow for delivery to the cylinder, and a variable position vane mechanism comprising a plurality of movable vanes arranged radially outward from and concentric with the turbine wheel and disposed between the turbine housing inlet and the turbine wheel. Each vane can include an actuating feature configured to be manipulated by a crown disposed radially inward from the plurality of actuating features. Manipulating each of the vanes via the crown can increase or decrease a pressure ratio of the VGT. The plurality of actuating features can be vane wheels. Each of the vane wheels can be parallel with the crown. Each of the vane actuating features can include a toothed edge, and the crown can include a toothed peripheral edge configured to engage the toothed edge of each vane actuating feature. The crown can include a central aperture through which the shaft is disposed. The vehicle can further include a crown actuator configured to effect rotation of the crown and subsequent movement of the plurality of vanes.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a schematic of a vehicle, according to one or more embodiments;

FIG. 2 illustrates a schematic view of an engine, according to one or more embodiments;

FIG. 3 illustrates a cross-sectional view of a variable geometry turbocharger, according to one or more embodiments;

FIG. 4 illustrates perspective view of a variable position vane mechanism for a variable geometry turbocharger, according to one or more embodiments;

FIG. 5 illustrates a top view of a variable position vane mechanism, according to one or more embodiments;

FIG. 6A illustrates a schematic cross-sectional view of a variable geometry turbocharger in a high-flow exhaust state, according to one or more embodiments; and

FIG. 6B illustrates a schematic cross-sectional view of a variable geometry turbocharger in a low-flow exhaust state, according to one or more embodiments.

### DETAILED DESCRIPTION

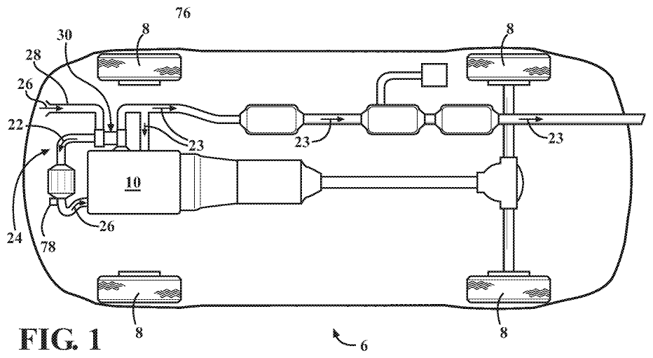

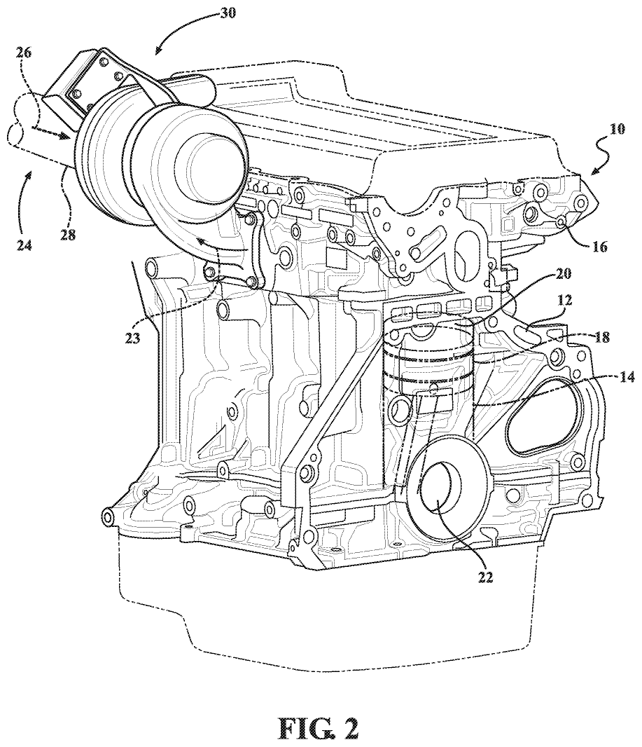

Referring to the drawings wherein like reference numbers correspond to like or similar components throughout the several figures, FIG. 1 illustrates a vehicle 6 having a plurality of wheels 8 that may be driven by an internal combustion engine (ICE) 10. As shown in FIG. 2, the ICE 10 includes a cylinder block 12 with one or a plurality of cylinders 14 arranged therein. The ICE 10 also includes a cylinder head 16. Each cylinder 14 includes a piston 18 configured to reciprocate therein. The ICE 10 may be a spark ignition or a compression ignition design.

As shown in FIG. 2, combustion chambers 20 are formed within the cylinders 14 between the bottom surface of the cylinder head 16 and the tops of the pistons 18. As known by those skilled in the art, combustion chambers 20 are configured to receive fuel and air such that a fuel-air mixture may form for subsequent combustion therein. The ICE 10 also includes a crankshaft 22 configured to rotate within the cylinder block 12. The crankshaft 22 is rotated by the pistons 18 as a result of increased pressure from the burning fuel-air mixture in the combustion chambers 20. After the air-fuel mixture is burned inside a specific combustion chamber 20, the reciprocating motion of a particular piston 18 serves to exhaust post-combustion gases 23 from the respective cylinder 14.

The ICE 10 also includes an induction system 24 configured to channel an airflow 26 from the ambient to the cylinders 14. The induction system 24 includes an intake air duct 28, a variable geometry turbocharger (VGT) 30, and an intake manifold (not shown). Although not shown, the induction system 24 may additionally include an air filter upstream of the VGT 30 for removing foreign particles and other airborne debris from the airflow 26. The intake air duct 28 is configured to channel the airflow 26 from the ambient to the VGT 30, while the VGT is configured to pressurize the received airflow, and discharge the pressurized airflow to the intake manifold. The intake manifold in turn distributes the previously pressurized airflow 26 to the cylinders 14 for mixing with an appropriate amount of fuel and subsequent combustion of the resultant fuel-air mixture.

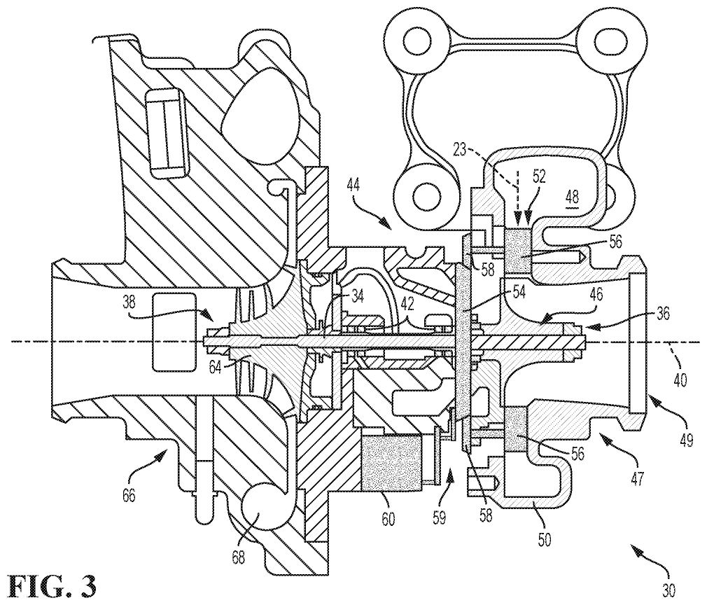

As shown in FIG. 3, the VGT 30 includes a shaft 34 having a first end 36 and a second end 38. The shaft 34 is supported for rotation about an axis 40 via bearings 42. For example, the bearings 42 can be mounted in a bearing housing 44 and may be lubricated by a supply of oil. A turbine wheel 46 is mounted on the shaft 34 proximate to the first end 36 and configured to be rotated about the axis 40 by post-combustion gasses 23 emitted from the cylinders 14. The turbine wheel 46 is retained inside a turbine housing 47 that includes a volute or scroll 50. The scroll 50 defines a turbine housing inlet 48 to the turbine wheel 46. The scroll 50 receives the post-combustion exhaust gases 23 and directs the exhaust gases to the turbine wheel 46 through the inlet 48. As a result, the turbine wheel 46 and the shaft 34 are rotated by post-combustion gasses 23 about the axis 40. The scroll 50 is configured to achieve specific performance characteristics, such as efficiency and response, of the VGT 30.

The VGT 30 further includes a compressor wheel 64 mounted on the common shaft 34 between the first and second ends 36, 38. The compressor wheel 64 is configured to pressurize the airflow 26 being received from the ambient for eventual delivery to the cylinders 14. The compressor wheel 64 is retained inside a compressor cover 66 that includes a volute or scroll 68. The scroll 68 receives the airflow 26 from the compressor wheel 64 after the airflow has been compressed. The scroll 68 is configured to achieve specific performance characteristics, such as peak airflow and efficiency of the VGT 30. Accordingly, rotation is imparted to the shaft 34 by the post-combustion exhaust gases 23 energizing the turbine wheel 46, and is in turn communicated to the compressor wheel 64 owing to the compressor wheel being fixed on the shaft. As understood by those skilled in the art, the variable flow rates and enthalpy of the post-combustion exhaust gases 23 influence the amount of boost pressure that may be generated by the compressor wheel 64 throughout the operating range of the ICE 10.

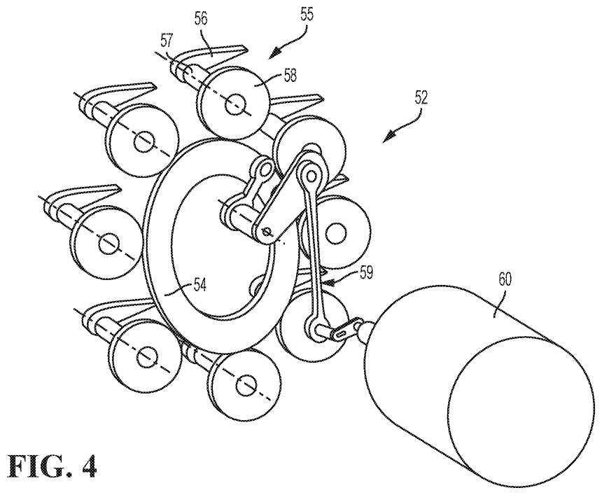

The VGT 30 further includes a variable position vane mechanism 52. FIG. 4 illustrates a perspective view of the variable position vane mechanism 52. As shown, the vane mechanism 52 includes a plurality of annularly arranged movable vanes 55 arranged between the inlet 48 and the turbine wheel 46. Each vane 55 includes a vane body 56, an actuating feature 58, and optionally a vane post 57 coupling the vane body 56 to the actuating feature 58. The vanes 56 are configured to move relative to the turbine housing 47 in order to select a specific pressure ratio (PR) of the inlet 48 to the turbine wheel 46. As understood by those skilled in the art, the PR is defined as the ratio of the pressure at the turbine inlet 48 and the turbine outlet 49. A circular crown 54 is engaged with the plurality of vane actuating features 58, and is disposed concentric therewith and radially inward therefrom. Accordingly, the inwardly-disposed crown 54 reduces the overall packaging size of the VGT 30 without sacrificing functionality.

Rotation of the circular crown 54 effects movement of the plurality of vane bodies 56, for example to achieve a desired PR. The crown 54 may be rotated by an actuator 60 which can be coupled to the crown 54 by a linkage assembly 59, for example. The linkage assembly 59 may take comprise various numbers, shapes, and sizes of linkages, as will be known by one of skill in the art, suitable to effect desired rotation of the crown 54 within the packaging constraints of the VGT 30. The linkage assembly 59 is shown as comprising different numbers or linkages in FIG. 3 and FIG. 4 to illustrate that a variety of configurations, including those not shown, are practicable and germane to the disclosure herein.

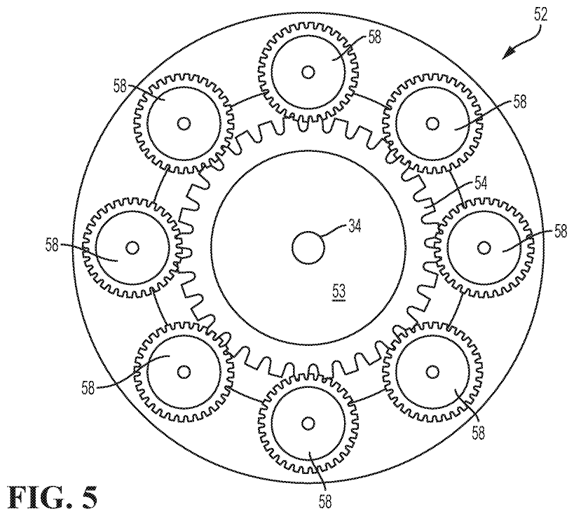

The plurality of actuating features 58 can comprise a vane wheel, such as those shown in FIG. 4. Each of the vane wheels can be parallel with the crown 54. FIG. 5 illustrates a top view of a variable position vane mechanism 52. The crown comprises a central aperture 53 through which the shaft 34 is disposed. As shown, each of the vane actuating features 58 comprises a toothed edge, and the crown 54 comprises a toothed peripheral edge configured to engage the toothed edge of each vane actuating feature 58. The vane actuating features 58 and crown 54 are illustrated having an entirely toothed edge, but the vane actuating features 58 and/or crown 54 may alternatively comprise a partially toothed edge sufficient to effect suitable movement of each vane actuating feature 58. For example, in some embodiments a vane actuating feature may comprise a peripheral edge which comprises teeth over about 30% of the peripheral edge.

The vane mechanism 52 may also include an actuator 60. As shown, the actuator 60 is configured to selectively vary the position of the vane mechanism 52, and specifically the vane bodies 56 to select a specific PR of the VGT 30. The actuator 60 may have an electro-mechanical configuration, such that the actuator 60 is in electronic communication with an external command source, such as a controller (not shown), and able to control the position of the vanes 56 and effect a desired PR to satisfy various operating needs of the VGT 30 or vehicle 6. For example, the actuator 60 can receive a command signal from a controller to vary the position of the vanes 56 and achieve a specific PR of the VGT 30.

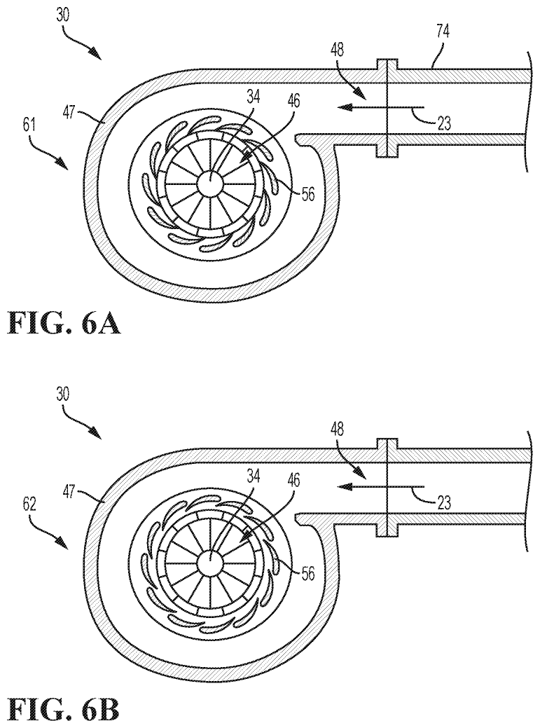

The vane mechanism 52 is configured to selectively alter the effective PR of the VGT 30 by altering the effective geometry of the turbine housing 47 in line with operating speed of the ICE 10 and thus facilitate increased ICE operating efficiency. FIGS. 6A and 6B illustrate two operating states of the VGT 30. In FIGS. 6A-B, the crown 54 and vane actuating features 58 are omitted for clarity. FIG. 6A illustrates the VGT 30 in a high-flow exhaust state 61, and FIG. 6B illustrates the VGT 30 in a low-flow exhaust state 62. In the high-flow state 61, each of the plurality of vane bodies 56 are articulated to an “open” position, whereby the exhaust post-combustion gases 23 may be more freely allowed to contact the turbine wheel 46. In the low-flow state 62, each of the plurality of vane bodies 56 are articulated to a “substantially closed” position, whereby the exhaust post-combustion gases 23 are nozzled toward the turbine wheel 46.

Operating efficiency of the ICE 10 can be increased through the use of the vane mechanism 52 because during lower operating speeds of a typical ICE optimum PR is very different from the PR that would be optimum during higher operating speeds. By altering the geometry of the turbine housing 47 as the ICE 10 accelerates, the PR of VGT 30 can be maintained near its optimum. As a consequence of its ability to operate near optimum PR, VGT 30 will exhibit a reduced amount of boost lag, have a lower boost threshold, and will also be more efficient at higher engine speeds in comparison to a fixed geometry turbocharger. An additional benefit in the VGT 30 is that the VGT does not require a wastegate to regulate rotational speed of the turbine wheel 46.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A variable position vane mechanism for a variable geometry turbocharger, the mechanism comprising:
a plurality of annularly arranged vanes each comprising a vane body and an actuating feature coupled to the vane body via a vane post; and
a circular crown engaged with the plurality of vane actuating features and disposed concentric therewith and radially inward therefrom;
wherein rotation of the circular crown effects movement of the plurality of vanes.

2. The variable position vane mechanism of claim 1, wherein the plurality of actuating features each comprises a vane wheel.

3. The variable position vane mechanism of claim 2, wherein each of the vane wheels are parallel with the crown.

4. The variable position vane mechanism of claim 1, wherein each of the vane actuating features comprises a toothed edge, and the crown comprises a toothed peripheral edge configured to engage the toothed edge of each vane actuating feature.

5. The variable position vane mechanism of claim 1, wherein the crown comprises a central aperture.

6. The variable position vane mechanism of claim 1, further comprising a crown actuator coupled to the crown via a linkage assembly and configured to effect rotation of the crown and subsequent movement of the plurality of vanes.

7. A variable geometry turbocharger (VGT) comprising:
a turbine housing;
a turbine wheel disposed within the turbine housing and configured to be rotated by post-combustion gasses communicated to the turbine wheel via a turbine housing inlet;
a compressor wheel operably connected to the turbine wheel via a shaft; and
a variable position vane mechanism comprising a plurality of movable vanes arranged radially outward from and concentric with the turbine wheel and disposed between the turbine housing inlet and the turbine wheel, wherein each vane comprises an actuating feature configured to be manipulated by a crown disposed radially inward from the plurality of actuating features.

8. The VGT of claim 7, wherein manipulating each of the vanes via the crown increases or decreases a pressure ratio of the VGT.

9. The VGT of claim 7, wherein the plurality of actuating features each comprises a vane wheel.

10. The VGT of claim 9, wherein each of the vane wheels are parallel with the crown.

11. The VGT of claim 7, wherein each of the vane actuating features comprises a toothed edge, and the crown comprises a toothed peripheral edge configured to engage the toothed edge of each vane actuating feature.

12. The VGT of claim 7, wherein the crown comprises a central aperture through which the shaft is disposed.

13. The VGT of claim 7, further comprising a crown actuator configured to effect rotation of the crown and subsequent movement of the plurality of vanes.

14. A vehicle comprising:
an internal combustion engine including:
a cylinder configured to receive an air-fuel mixture for combustion therein;
a reciprocating piston disposed inside the cylinder and configured to exhaust post-combustion gasses from the cylinder; and
a variable geometry turbocharger (VGT) including:
a turbine housing,
a turbine wheel disposed within the turbine housing and configured to be rotated by post-combustion gasses communicated to the turbine wheel via a turbine housing inlet,
a compressor wheel operably connected to the turbine wheel via a shaft and configured to pressurize a compressor supply airflow for delivery to the cylinder, and
a variable position vane mechanism comprising a plurality of movable vanes arranged radially outward from and concentric with the turbine wheel and disposed between the turbine housing inlet and the turbine wheel, wherein each vane comprises an actuating feature configured to be manipulated by a crown disposed radially inward from the plurality of actuating features.

15. The vehicle of claim 14, wherein manipulating each of the vanes via the crown increases or decreases a pressure ratio of the VGT.

16. The vehicle of claim 14, wherein the plurality of actuating features each comprises a vane wheel.

17. The vehicle of claim 16, wherein each of the vane wheels are parallel with the crown.

18. The vehicle of claim 14, wherein each of the vane actuating features comprises a toothed edge, and the crown comprises a toothed peripheral edge configured to engage the toothed edge of each vane actuating feature.

19. The vehicle of claim 14, wherein the crown comprises a central aperture through which the shaft is disposed.

20. The vehicle of claim 14, further comprising a crown actuator configured to effect rotation of the crown and subsequent movement of the plurality of vanes.
